(19) United States
(12) Patent Application Publication
(10) Pub. No.: US 2007/0216608 A1
(43) Pub. Date: Sep. 20, 2007

(54) Method of driving plasma display apparatus

(75) Inventor: Jeong Pil Choi, Suwon-si (KR)

Correspondence Address: KED & ASSOCIATES, LLP, P.O. Box 221200, Chantilly, VA, 20153-1200, US

(73) Assignee: LG Electronics Inc.

(21) Appl. No.: 11/717,049

(22) Filed: Mar. 13, 2007

(30) Foreign Application Priority Data
Mar. 14, 2006 (KR) 10-2006-0023591

(51) Int. Cl. G09G 3/28

(52) U.S. Cl. 345/67

(57) ABSTRACT

A method of driving a plasma display apparatus is disclosed. In the method, a first pulse with a gradually rising voltage is applied to a scan electrode during a setup period of a reset period. A second pulse gradually falling from a first voltage to a second voltage is applied to the scan electrode during a set-down period of a reset period. A positive third voltage is applied to an address electrode during the set-down period. A voltage of the address electrode floats during the set-down period after applying the third voltage.

This application claims the benefit of Korean Patent Application No. 10-2006-0023591 filed on Mar. 14, 2006, which is hereby incorporated by reference.

### BACKGROUND

1. Field

This document relates to a display apparatus, and more particularly, to a method of driving a plasma display apparatus.

2. Description of the Related Art

Out of display apparatuses, a plasma display apparatus comprises a plasma display panel and a driver for driving the plasma display panel.

The plasma display panel has the structure in which barrier ribs formed between a front panel and a rear panel forms unit discharge cell or discharge cells. Each discharge cell is filled with an inert gas containing a main discharge gas such as neon (Ne), helium (He) or a mixture of Ne and He, and a small amount of xenon (Xe).

The plurality of discharge cells form one pixel. For example, a red (R) discharge cell, a green (G) discharge cell, and a blue (B) discharge cell form one pixel.

When the plasma display panel is discharged by a high frequency voltage, the inert gas generates vacuum ultraviolet rays, which thereby cause phosphors formed between the barrier ribs to emit light, thus displaying an image. Since the plasma display panel can be manufactured to be thin and light, it has attracted attention as a next generation display device.

### SUMMARY

In one aspect, a method of driving a plasma display apparatus comprises applying a first pulse with a gradually rising voltage to a scan electrode during a setup period of a reset period, applying a second pulse gradually falling from a first voltage to a second voltage to the scan electrode during a set-down period of a reset period, applying a positive third voltage to an address electrode during the set-down period, and causing a voltage of the address electrode to float during the set-down period after applying the third voltage.

A time period for which the voltage of the address electrode float may range from 1 μs to 50 μs.

A time period for which the voltage of the address electrode floats may substantially occupy two thirds of a duration of the set-down period from an end of the set-down period.

The method may further comprise applying a positive fourth voltage to a sustain electrode during the set-down period, and causing a voltage of the sustain electrode to float during the set-down period after applying the fourth voltage.

A start time point at which the voltage of the sustain electrode floats may be substantially equal to a start time point at which the voltage of the address electrode floats.

The third voltage may be substantially equal to a data voltage applied to the address electrode during an address period.

The fourth voltage may be substantially equal to a sustain voltage applied to the sustain electrode during a sustain period.

The second pulse may gradually fall from the first voltage to the second voltage, and may be then maintained at the second voltage.

The second voltage may be substantially equal to a scan voltage applied to the scan electrode during an address period.

In another aspect, a method of driving a plasma display apparatus comprises applying a first pulse with a gradually rising voltage to a scan electrode during a setup period of a reset period, applying a second pulse gradually falling from a first voltage to a second voltage to the scan electrode during a set-down period of a reset period, causing a voltage of an address electrode to float during the setup period, applying a positive third voltage to the address electrode during the set-down period, and causing a voltage of the address electrode to float during the set-down period after applying the third voltage.

A time period for which the voltage of the address electrode floats during the set-down period may range from 1 μs to 50 μs.

A time period for which the voltage of the address electrode floats during the set-down period may substantially occupy two thirds of a duration of the set-down period from an end of the set-down period.

The method may further comprise applying a positive fourth voltage to a sustain electrode during the set-down period, and causing a voltage of the sustain electrode to float during the set-down period after applying the fourth voltage.

A start time point at which the voltage of the sustain electrode floats during the set-down period may be substantially equal to a start time point at which the voltage of the address electrode floats during the set-down period.

The third voltage may be substantially equal to a data voltage applied to the address electrode during an address period.

The fourth voltage may be substantially equal to a sustain voltage applied to the sustain electrode during a sustain period.

The second pulse may gradually fall from the first voltage to the second voltage, and may be then maintained at the second voltage.

The second voltage may be substantially equal to a scan voltage applied to the scan electrode during an address period.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention.

FIG. 1 illustrates a plasma display apparatus according to embodiments;

FIG. 2 illustrates one example of the structure of a plasma display panel of the plasma display apparatus according to the embodiments;

FIG. 3 illustrates a driving waveform generated by a driving method of a plasma display apparatus according to a first embodiment;

FIG. 4 illustrates a driving waveform generated by a driving method of a plasma display apparatus according to a second embodiment;

FIG. 5 illustrates a driving waveform generated by a driving method of a plasma display apparatus according to a third embodiment;

FIG. 6 illustrates a driving waveform generated by a driving method of a plasma display apparatus according to a fourth embodiment;

FIG. 7 illustrates a driving waveform generated by a driving method of a plasma display apparatus according to a fifth embodiment; and

FIG. 8 illustrates a driving waveform generated by a driving method of a plasma display apparatus according to a sixth embodiment.

### DETAILED DESCRIPTION OF PREFERRED EMBODIMENTS

Reference will now be made in detail embodiments of the invention examples of which are illustrated in the accompanying drawings.

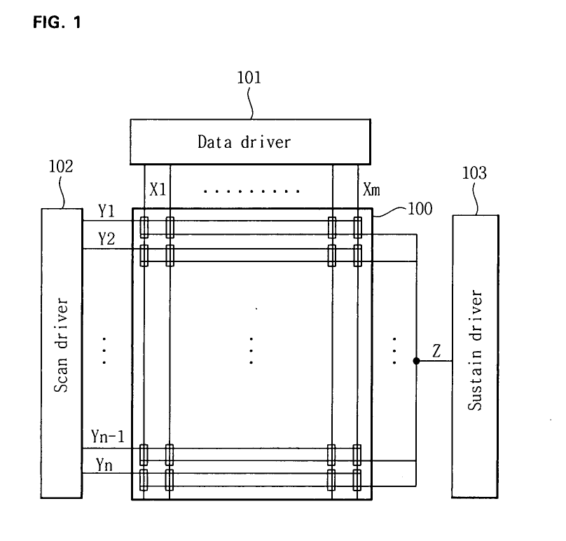

FIG. 1 illustrates a plasma display apparatus according to embodiments.

Referring to FIG. 1, the plasma display apparatus according to the embodiments includes a plasma display panel 100 and a driver for applying a predetermined driving voltage to electrodes of the plasma display panel 100. The driver includes a data driver 101, a scan driver 102, and a sustain driver 103.

The scan driver 102 and the sustain driver 103 may correspond to a first driver. The data driver 101 may correspond to a second driver.

The plasma display panel 100 includes a front panel (not illustrated) and a rear panel (not illustrated) which are coalesced at a given distance therebetween, and a plurality of electrodes. The plurality of electrodes include scan electrode Y1 to Yn, sustain electrodes Y, and address electrodes X1 to Xn.

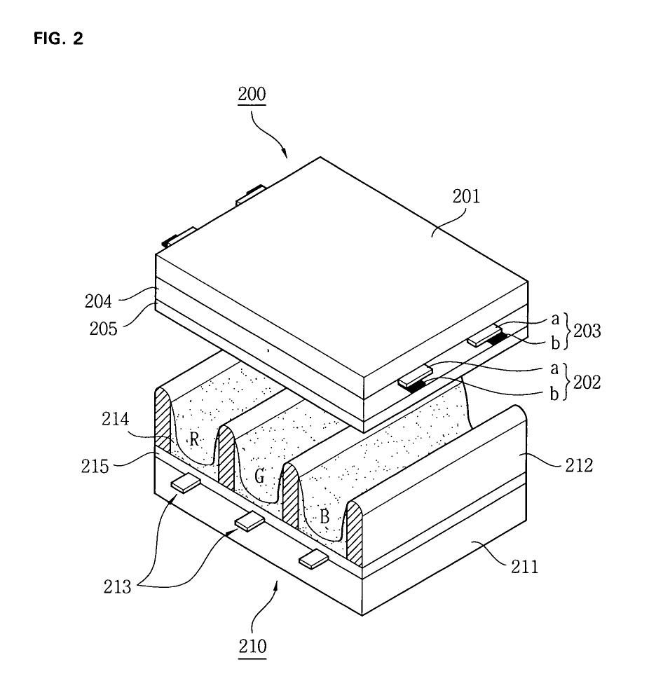

The following is a detailed description of the structure of the plasma display panel 100 with reference to FIG. 2.

As illustrated in FIG. 2, the plasma display panel 100 of the plasma display apparatus according to the embodiments includes a front panel 200 and a rear panel 210 which are coupled in parallel opposite to each other at a given distance therebetween. The front panel 200 includes a front substrate 201 being a display surface on which an image is displayed. The rear panel 210 includes a rear substrate 211 constituting a rear surface. A plurality of scan electrodes 202 and a plurality of sustain electrodes 203 are formed on the front substrate 201. A plurality of address electrodes 213 are arranged on the rear substrate 211 to intersect the scan electrodes 202 and the sustain electrodes 203.

The scan electrode 202 and the sustain electrode 203 each include transparent electrodes 202a and 203a made of transparent indium-tin-oxide (ITO) material, and bus electrodes 202b and 203b made of a metal material. The scan electrode 202 and the sustain electrode 203 generate a mutual discharge therebetween in one discharge cell, and maintain light-emissions of the discharge cells.

The scan electrode 202 and the sustain electrode 203 are covered with one or more upper dielectric layers 204 for limiting a discharge current and providing insulation between the scan electrode 202 and the sustain electrode 203. A protective layer 205 with a deposit of MgO is formed on an upper surface of the upper dielectric layer 204 to facilitate discharge conditions.

A plurality of stripe-type (or well-type) barrier ribs 212 are arranged in parallel on the rear substrate 211 of the rear panel 210 to form a plurality of discharge spaces (i.e., a plurality of discharge cells). The plurality of address electrodes 213 for performing an address discharge to generate vacuum ultraviolet rays are arranged in parallel to the barrier ribs 212.

An upper surface of the rear panel 210 is coated with Red (R), green (G) and blue (B) phosphors 214 for emitting visible light for an image display during the generation of the address discharge is performed. A lower dielectric layer 215 is formed between the address electrodes 213 and the phosphors 214 to protect the address electrodes 213.

Although FIG. 2 has illustrated and described only one example of the plasma display panel applicable to the embodiments, the embodiments are not limited to the structure of the plasma display panel illustrated in FIG. 2.

For example, FIG. 2 has illustrated the scan electrode 202 and the sustain electrode 203 each including the transparent electrode and the bus electrode. However, at least one of the scan electrode 202 and the sustain electrode 203 may include either the bus electrode or the transparent electrode.

Further, FIG. 2 has illustrated and described the structure of the plasma display panel, in which the front panel 200 includes the scan electrode 202 and the sustain electrode 203 and the rear panel 210 includes the address electrode 213. However, the front panel 200 may include all of the scan electrode 202, the sustain electrode 203, and the address electrode 213. At least one of the scan electrode 202, the sustain electrode 203, and the address electrode 213 may be formed on the barrier rib 212.

Considering the structure of the plasma display panel of FIG. 2, the plasma display panel applicable to the embodiments has only to include the scan electrode 202, the sustain electrode 203, and the address electrode 210. The plasma display panel may have various structures as long as the above-described structural characteristics are satisfied.

The description of FIG. 2 is completed, and the description of FIG. 1 continues again.

The scan driver 102 supplies a setup pulse and a set-down pulse to the scan electrode Y of the plasma display panel 100 during a reset period. Further, the scan driver 102 supplies a scan pulse to the scan electrode Y during an address period, and supplies a sustain pulse to the scan electrode Y during a sustain period.

The sustain driver 103 supplies a sustain pulse to the sustain electrode Z during the sustain period. The scan driver 102 and the sustain driver 103 alternately operate during the sustain period.

The data driver 101 supplies a data pulse to the address electrode X during the address period.

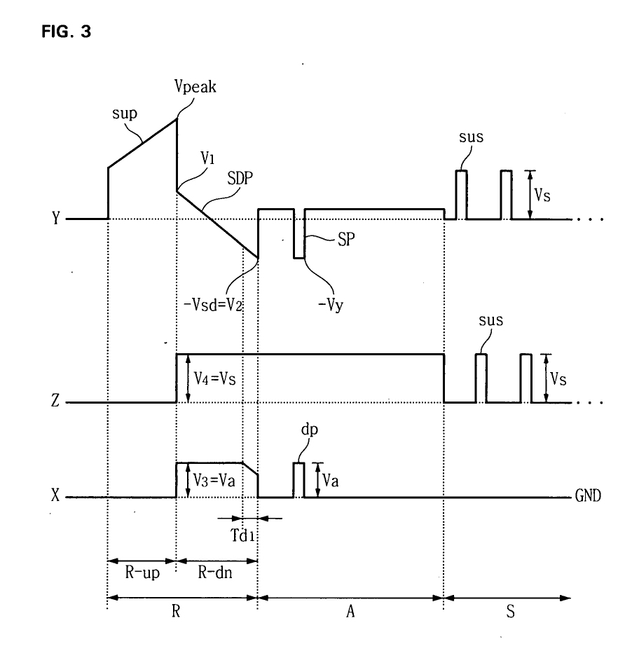

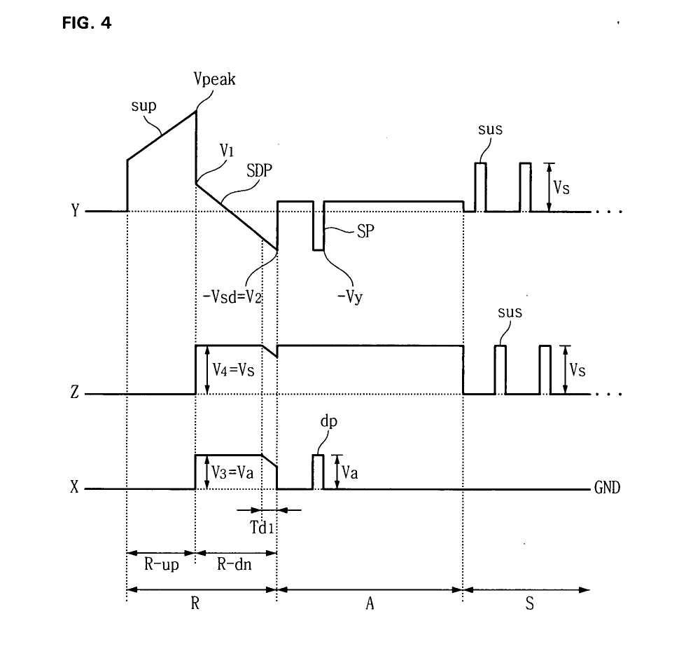

FIG. 3 illustrates a driving waveform generated by a driving method of a plasma display apparatus according to a first embodiment. FIG. 4 illustrates a driving waveform generated by a driving method of a plasma display apparatus according to a second embodiment.

Referring to FIG. 3, the driving method of the plasma display apparatus according to the first embodiment is performed with one subfield being divided into a reset period (R) during which the whole screen is initialized, an address period (A) during which scan lines are selected and discharge cells are selected from the selected scan lines, and a sustain period (S) during which a gray level is represented in accordance with the number of discharges.

The reset period (R) is subdivided into a setup period (R_up) and a set-down period (R_dn). During the setup period (R_up), a setup pulse sup (i.e., a first pulse) gradually rising from a positive voltage to a peak voltage Vpeak is applied to the scan electrode Y. With the application of the setup pulse sup, a weak discharge occurs inside the discharge cells of the whole screen such that wall charges are generated inside the discharge cells.

During the set-down period (R_dn), a set-down pulse SDP (i.e., a second pulse) gradually falling from a positive first voltage V1, that is lower than the peak voltage Vpeak of the setup pulse SUP, to a negative set-down voltage −Vsd (i.e., a second voltage −V2) is applied to the scan electrode Y. With the application of the set-down pulse SDP, a weak erase discharge occurs inside the discharge cells such that wall charges excessively generated prior to the generation of the weak erase discharge are erased. The remaining wall charges inside the discharge cells are uniform.

A positive third voltage V3 is applied to the address electrode X in the first half of the set-down period (R_dn). The third voltage V3 may be substantially equal to a voltage Va (i.e., a data voltage Va) of a data pulse dp applied to the address electrode X during the address period (A) which follows the reset period (R).

A voltage of the address electrode X floats for a predetermined time period of the set-down period (R_dn). The voltage of the address electrode X is maintained in a floating state for a predetermined time period Td1 of the set-down period (R_dn) until the set-down pulse SDP reaches the lowest voltage −Vsd (=V2) of the set-down pulse SDP. The predetermined time period Td1 for which the voltage of the address electrode X floats ranges from 1 μs to 50 μs.

The time period Td1 for which the voltage of the address electrode X floats substantially occupies two thirds of the set-down period (R_dn) from an end of the set-down period (R_dn). For example, supposing that the set-down period (R_dn) is equal to 100 μs, the positive third voltage V3 is applied to the address electrode X from the start of the set-down period (R_dn) to 33 μs, and then the voltage of the address electrode X floats for the remaining time period (corresponding to 66 μs) of the set-down period (R_dn).

A floating voltage of the address electrode X is output by turning off all of one or more switch elements (not illustrated) used to apply the data voltage Va and a ground level voltage to the address electrode X.

During the address period (A), a scan pulse sp of a negative polarity is applied to the scan electrode Y and, at the same time, the data pulse dp of a positive polarity is applied to the address electrode X. This results in the occurrence of an address discharge inside the discharge cells and the generation of wall charges inside the discharge cells selected by performing the address discharge.

As illustrated in FIG. 4, a positive fourth voltage V4 is applied to the sustain electrode Z during a set-down period (R_dn) and an address period (A). The fourth voltage V4 may be substantially equal to a voltage Vs (i.e., a sustain voltage Vs) of a sustain pulse sus applied to the sustain electrode Z during a sustain period (S).

A voltage applied to the sustain electrode Z floats for a predetermined time period Td1 of the set-down period (R_dn). A floating voltage of the sustain electrode Z is output by turning off all of one or more switch elements (not illustrated) used to apply the sustain voltage Vs and a ground level voltage to the sustain electrode Z.

A start time point at which the voltage of the sustain electrode Z floats may be substantially equal to a start time point at which the voltage of the address electrode X floats. In other words, a start time point at which all of the one or more switch elements used to apply the data voltage Va and the ground level voltage to the address electrode X are turned off may be equal to a start time point at which all of the one or more switch elements used to apply the sustain voltage Vs and the ground level voltage to the sustain electrode Z are turned off.

When all the switch elements connected to the address electrode X or the sustain electrode Z are turned off for the predetermined time period Td1 of the set-down period (R_dn), the floating voltage of the address electrode X or the sustain electrode Z falls with a slope similar to a slope of a set-down pulse SDP applied to the scan electrode Y.

When the voltage of the sustain electrode Z floats for the predetermined time period Td1, a discharge between the scan electrode Y and the sustain electrode Z stops. This results in a reduction in the quantity of light generated during a reset period (R). Accordingly, a black luminance of the plasma display apparatus is improved such that contrast characteristics of the plasma display apparatus are improved.

Sustain pulses sus are alternately applied to the scan electrode Y and the sustain electrode Z during the sustain period (S) such that a sustain discharge occurs. An image is displayed on the plasma display panel through the sustain pulses sus.

As above, while the voltage of the address electrode X floats for the predetermined time period Td1, the voltage of the sustain electrode Z floats for the predetermined time period Td1. Therefore, a stable discharge occurs between the scan electrode Y and the address electrode X by preventing changes in a state of wall charges distributed in the address electrode X.

In a case where the lowest voltage −Vsd (=V2) of the set-down pulse SDP is slightly higher than the voltage −Vy of the scan pulse sp, it is allowed the voltage of the address electrode X or the sustain electrode Z to float before the set-down pulse SDP of the scan electrode Y reaches the lowest voltage −Vsd (=V2).

In this case, since an erase discharge between the scan electrode Y and the sustain electrode Z does not occur during the application period Td1 of the floating voltage, a reduction in the contrast characteristics during the reset period (R) is prevented without a change in a separate circuit configuration

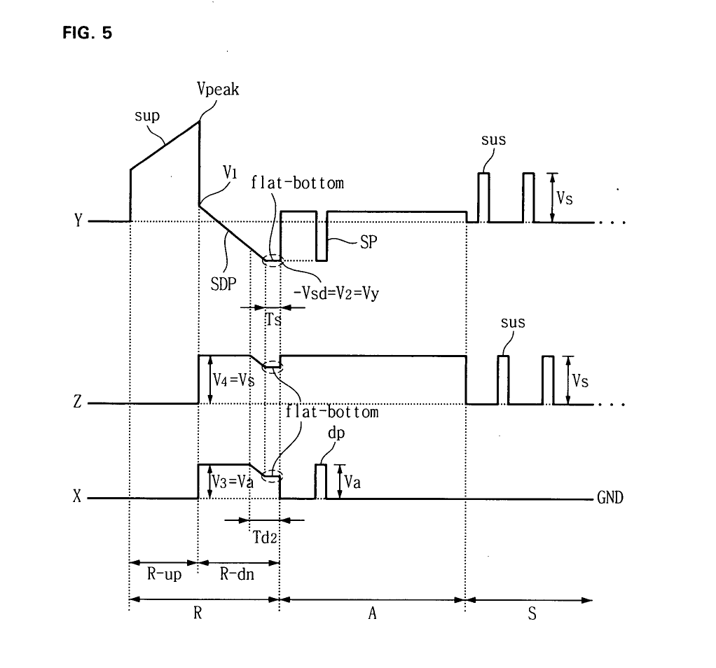

FIG. 5 illustrates a driving waveform generated by a driving method of a plasma display apparatus according to a third embodiment.

As illustrated in FIG. 5, a voltage of the address electrode X floats for a predetermined time period Td2 of a set-down period (R_dn), and a floating voltage of the address electrode X is maintained at a predetermined voltage for a predetermined time period.

When all switch elements (not illustrated) connected to the address electrode X are turned off in the second half of the set-down period (R_dn), the voltage of the address electrode X floats such that the floating voltage of the address electrode X falls with a slope similar to a slope of a set-down pulse SDP applied to the scan electrode Y.

When the set-down pulse SDP falls to the lowest voltage −Vsd (=V2) of the set-down pulse SDP and is then maintained at the lowest voltage −Vsd (=V2) for a predetermined time period Ts, the floating voltage of the address electrode X falls with the slope similar to the slope of the set-down pulse SDP and is then maintained at a predetermined voltage for the predetermined time period Ts.

A peak portion of the set-down pulse SDP is flatly formed such that the floating voltage of the address electrode X has a flat bottom maintained at the predetermined voltage for the predetermined time period Ts. This results in the stabilization of wall charges formed inside the discharge cells.

A voltage of the sustain electrode Z floats for the predetermined time period Td2 of the set-down period (R_dn).

The floating voltage of the sustain electrode Z falls with the slope similar to the slope of the set-down pulse SDP, and is then maintained at a predetermined voltage for the predetermined time period Ts. In this case, the floating voltage of the sustain electrode Z has a flat bottom maintained at the predetermined voltage for the predetermined time period Ts.

Since all of the scan electrode Y, the sustain electrode Z, and the address electrode X have the flat bottom for the predetermined period Ts of the set-down period (R_dn), a set-down discharge (i.e., an erase discharge) sufficiently occurs. Accordingly, a state of the wall charges distributed in the discharge cells is stable due to the set-down discharge such that a performance of an address discharge is improved.

All of the scan electrode Y, the sustain electrode Z, and the address electrode X have the flat bottom for the predetermined time period Ts and the switch elements connected to the address electrode X are turned off during the set-down period (R_dn), thereby causing the voltage of the address electrode X to float.

Accordingly, the remaining wall charges on the scan electrode Y, the sustain electrode Z, and the address electrode X are uniform due to the erase discharge generated in the set-down period (R_dn). The lowest voltage −Vsd (=V2) of the set-down pulse SDP applied to the scan electrode Y during the set-down period (R_dn) may be equal to or different from a voltage −Vy of a scan pulse sp applied to the scan electrode Y during the address period (A).

Since the contrast is reduced by the erase discharge generated during the set-down period (R_dn), the quantity of light generated during the generation of the erase discharge is reduced by reducing the intensity of the erase discharge. For this, the lowest voltage −Vsd (=V2) of the set-down pulse SDP was set to be slightly higher than the voltage −Vy of the scan pulse sp.

When the set-down pulse SDP reaches a predetermined voltage, it is necessary that a circuit or a separate voltage supply source for stopping a voltage drop applies the lowest voltage of the set-down pulse SDP.

However, in the present embodiment, the voltages of the sustain electrode Z and the address electrode X float for the predetermined time period Td2 such that the erase discharge between the scan electrode Y and the sustain electrode Z stops for the predetermined time period Td2. Therefore, the lowest voltage −Vsd (=V2) of the set-down pulse SDP is equal to the voltage −Vy of the scan pulse sp. In other words, the case where the lowest voltage −Vsd (=V2) is equal to the voltage −Vy has the same effect as the case where the lowest voltage −Vsd (=V2) is slightly higher than to the voltage −Vy.

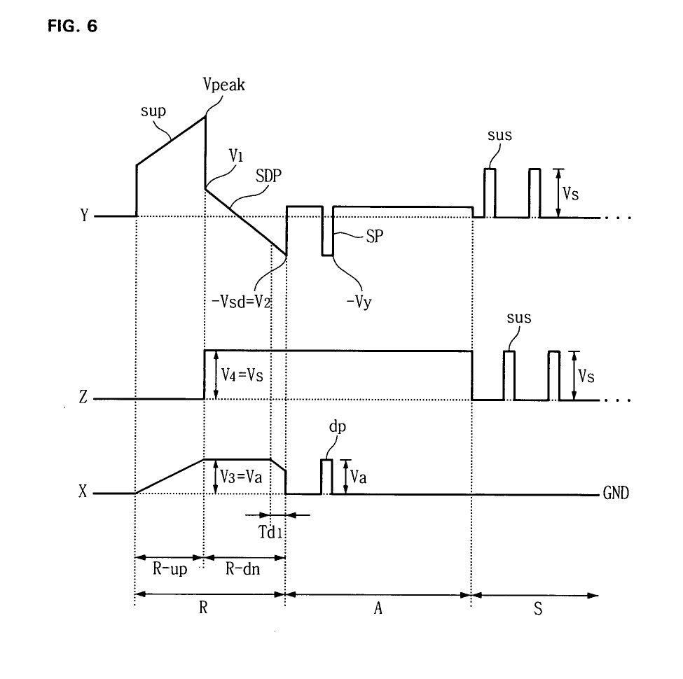

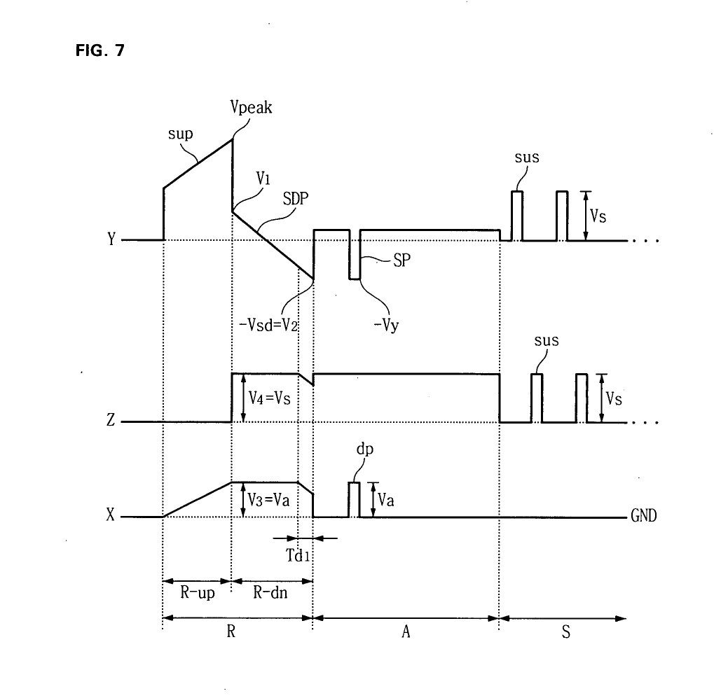

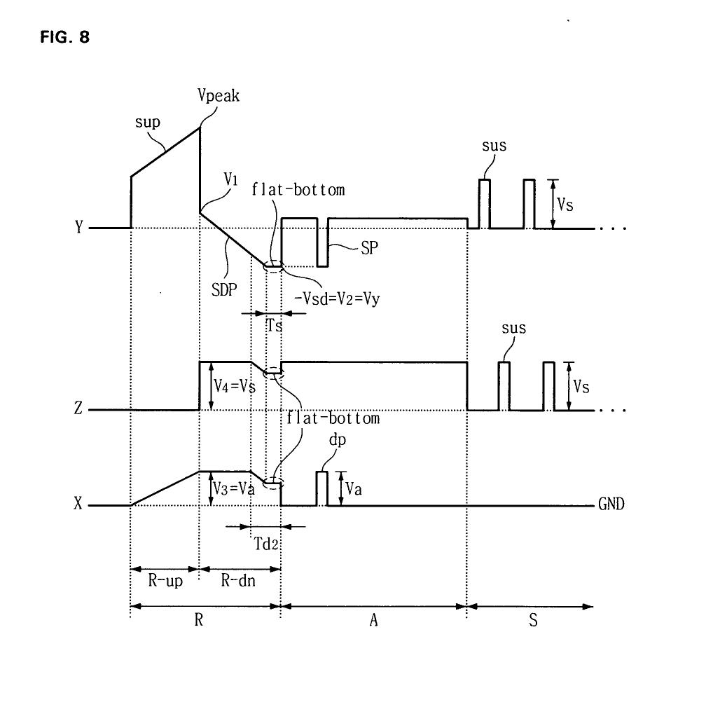

FIG. 6 illustrates a driving waveform generated by a driving method of a plasma display apparatus according to a fourth embodiment. FIG. 7 illustrates a driving waveform generated by a driving method of a plasma display apparatus according to a fifth embodiment. FIG. 8 illustrates a driving waveform generated by a driving method of a plasma display apparatus according to a sixth embodiment. Since the driving waveforms illustrated in FIGS. 6 to 8 are equal to the driving waveforms illustrated in FIGS. 3 to 5 except a driving waveform during a setup period, the driving waveform during the setup period will be described in detail below.

Referring to FIGS. 6 to 8, the driving method of the plasma display apparatus according to the fourth to sixth embodiments causes a voltage of the address electrode X to float by turning off a switch element connected to the address electrode X during a setup period (R_up).

In other words, when the setup period (R_up) starts, the voltage of the address electrode X floats by turning off a switch element used to apply a ground level voltage to the address electrode X. The voltage of the address electrode X rises due to a setup pulse sup (i.e., a first pulse) applied to the scan electrode X.

As above, when all of switch elements used to apply a data voltage Va and the ground level voltage to the address electrode X are turned off, the voltage of the address electrode X floats depending on a voltage of the scan electrode Y or the sustain electrode Z positioned opposite to the address electrode X.

Since a voltage of the sustain electrode is maintained at the ground level voltage and the setup pulse sup is applied to the scan electrode Y during the setup period (R_up), the voltage of the address electrode X has a rising waveform during the setup period (R_up).

Since a floating voltage of the address electrode X does not rise to a voltage that is higher than the highest voltage (i.e., a data voltage Va) applied to the address electrode X, the floating voltage of the address electrode X rises from the ground level voltage to the data voltage Va corresponding to the setup pulse sup of the scan electrode Y. When the voltage of the setup pulse sup is higher than the data voltage Va, the voltage of the address electrode X is clamped such that the voltage of the address electrode X no longer rise.

As the voltage of the address electrode X floats during the setup period (R_up), a state of wall charges accumulated on the address electrode X slowly changes while the voltage of the address electrode X rises to the data voltage Va. Accordingly, the plasma display apparatus is driven more stably.

As above, the driving method of the plasma display apparatus according to the embodiments improves the contrast characteristics by reducing the intensity of the discharge generated during the reset period, and improves the performance of the address discharge by stabilizing a state of wall charges distributed inside the discharge cells.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display apparatus comprising:
applying a first pulse with a gradually rising voltage to a scan electrode during a setup period of a reset period;
applying a second pulse gradually falling from a first voltage to a second voltage to the scan electrode during a set-down period of a reset period;
applying a positive third voltage to an address electrode during the set-down period; and
causing a voltage of the address electrode to float during the set-down period after applying the third voltage.

2. The method of claim 1, wherein a time period for which the voltage of the address electrode floats ranges from 1 μs to 50 μs.

3. The method of claim 1, wherein a time period for which the voltage of the address electrode floats substantially occupies two thirds of a duration of the set-down period from an end of the set-down period.

4. The method of claim 1, further comprising applying a positive fourth voltage to a sustain electrode during the set-down period, and
causing a voltage of the sustain electrode to float during the set-down period after applying the fourth voltage.

5. The method of claim 4, wherein a start time point at which the voltage of the sustain electrode floats is substantially equal to a start time point at which the voltage of the address electrode floats.

6. The method of claim 1, wherein the third voltage is substantially equal to a data voltage applied to the address electrode during an address period.

7. The method of claim 4, wherein the fourth voltage is substantially equal to a sustain voltage applied to the sustain electrode during a sustain period.

8. The method of claim 1, wherein the second pulse gradually falls from the first voltage to the second voltage, and is then maintained at the second voltage.

9. The method of claim 8, wherein the second voltage is substantially equal to a scan voltage applied to the scan electrode during an address period.

10. A method of driving a plasma display apparatus comprising:
applying a first pulse with a gradually rising voltage to a scan electrode during a setup period of a reset period;
applying a second pulse gradually falling from a first voltage to a second voltage to the scan electrode during a set-down period of a reset period;
causing a voltage of an address electrode to float during the setup period;
applying a positive third voltage to the address electrode during the set-down period; and
causing a voltage of the address electrode to float during the set-down period after applying the third voltage.

11. The method of claim 10, wherein a time period for which the voltage of the address electrode floats during the set-down period ranges from 1 μs to 50 μs.

12. The method of claim 10, wherein a time period for which the voltage of the address electrode floats during the set-down period substantially occupies two thirds of a duration of the set-down period from an end of the set-down period.

13. The method of claim 10, further comprising applying a positive fourth voltage to a sustain electrode during the set-down period, and
causing a voltage of the sustain electrode to float during the set-down period after applying the fourth voltage.

14. The method of claim 13, wherein a start time point at which the voltage of the sustain electrode floats during the set-down period is substantially equal to a start time point at which the voltage of the address electrode floats during the set-down period.

15. The method of claim 10, wherein the third voltage is substantially equal to a data voltage applied to the address electrode during an address period.

16. The method of claim 13, wherein the fourth voltage is substantially equal to a sustain voltage applied to the sustain electrode during a sustain period.

17. The method of claim 10, wherein the second pulse gradually falls from the first voltage to the second voltage, and is then maintained at the second voltage.

18. The method of claim 17, wherein the second voltage is substantially equal to a scan voltage applied to the scan electrode during an address period.
